(19) United States
(12) Patent Application Publication
(10) Pub. No.: US 2002/0198926 A1
(43) Pub. Date: Dec. 26, 2002

(54) Program management system and method

(76) Inventors: Gene L. Panter, Flint, MI (US); Kimberly K. Fizell, Goodrich, MI (US); Thomas J. Moore, Troy, MI (US); Theresa M. Tschirky, Troy, MI (US); David A. Cates, Richardson, TX (US)

Correspondence Address: Matthew B. Talpis, Esq., Baker Botts L.L.P., Suite 600, 2001 Ross Avenue, Dallas, TX, 75201-2980, US

(21) Appl. No.: 09/891,634

(22) Filed: Jun. 25, 2001

(51) Int. Cl. G06F 9/00

(52) U.S. Cl. 709/106

(57) ABSTRACT

A method for program management is presented. A governance structure is determined for a program. The governance structure provides leadership for the program and includes at least one member. At least one member of the governance structure applies at least one program management discipline to the program. At least one member of the governance structure applies knowledge management to the program. At least one member of the governance structure applies at least one project management methodology to at least one project associated with the program.

### BACKGROUND OF THE INVENTION

As society has grown increasingly complex, the scope of projects undertaken by companies has also increased in complexity. The increased complexity has increased the time, materials and resources required to manage projects. In addition, as a business undertakes multiple complex projects, difficulties are often encountered in managing multiple projects on an enterprise-wide basis.

Traditionally, various management techniques have been used for managing people and information associated with a project. The techniques have varies based on the number of people, the amount of data and other complexities associated with the project.

### SUMMARY OF THE INVENTION

The present invention provides a program management architecture. In a particular embodiment, management of programs and projects is enhanced using value management techniques.

According to one embodiment of the present invention, a method for program management is presented. A governance structure is determined for a program. The governance structure provides leadership for the program and includes at least one member. At least one member of the governance structure applies at least one program management discipline to the program. At least one member of the governance structure applies knowledge management to the program. At least one member of the governance structure applies at least one project management methodology to at least one project associated with the program.

The present invention provides various technical advantages. Various embodiments of the present invention may provide some, all or none of these technical advantages. One such technical advantage is the capability to manage multiple projects associated with a program at a program level. Another such technical advantage is the capability to apply value management techniques to a program.

Other technical advantages of the present invention will be readily apparent to one skilled in the art from the following figures, description, and claims.

### BRIEF DESCRIPTION OF THE DRAWINGS

The present invention is best understood from the detailed description which follows, taken in conjunction with the accompanying drawings, in which:

FIG. 1 is a block diagram illustrating a global program management architecture according to one embodiment of the present invention;

FIG. 1A is a block diagram illustrating a computer system operable to support the global program management architecture according to one embodiment of the present invention;

FIG. 2 is a block diagram illustrating stages associated with the program of FIG. 1 according to one embodiment of the present invention;

FIG. 3 is a flow chart illustrating a method for managing the program of FIG. 1 according to one embodiment of the present invention; and

FIG. 4 is a flow chart illustrating an exemplary embodiment of program value management associated with the program of FIG. 1 according to one embodiment of the present invention.

### DETAILED DESCRIPTION OF THE INVENTION

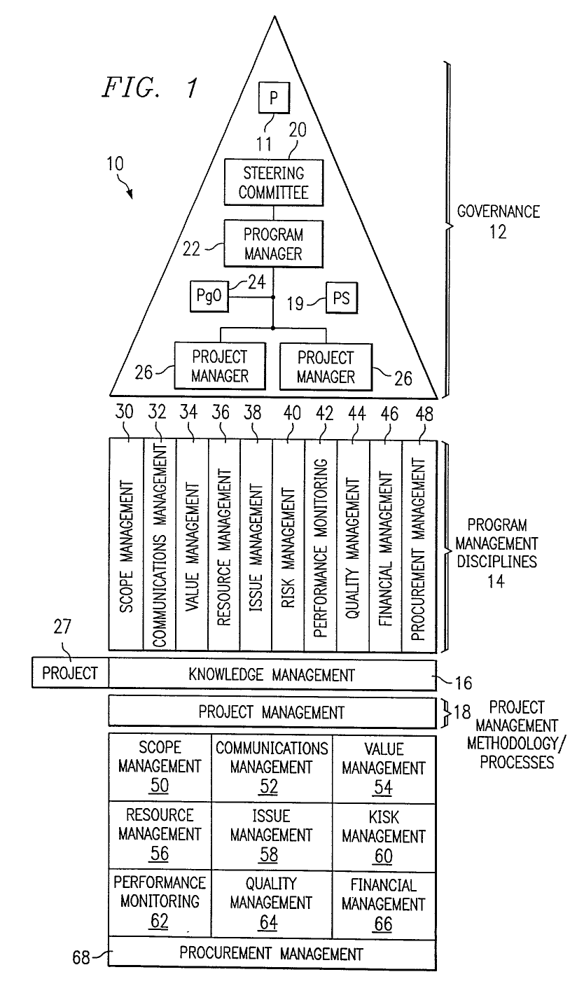

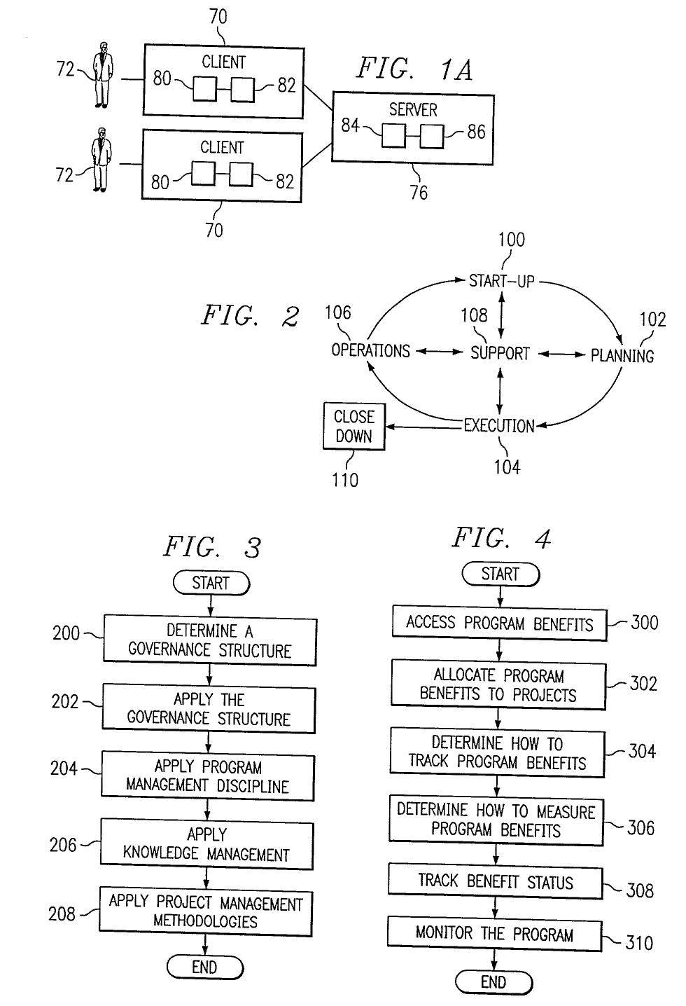

FIG. 1 is a block diagram illustrating a global program management architecture 10. Architecture 10 comprises managing one or more programs 11, a governance structure 12, one or more program management disciplines 14, knowledge management 16 and one or more project management methodologies 18.

In general, program management plans and implements strategic changes and realizes business benefits. Program management also provides leadership within a clear and structured framework where one can define organization change requirements, establish a benefits model, assess risks that may impact program benefit realization, prioritize elements of the program, and conduct a change impact analysis. In contrast, project management concentrates on the scope, planning, management and project control on a day-to-day basis and within a defined start and finish time period. Project management is expected to deliver results within specified parameters of cost, time and quality. Also, projects are typically associated with a specific business need.

Program management involves the administration of a group of projects that together achieve one or more business objectives to enhance the value of their collective benefits. A project is focused on achieving a specific objective, while a program is focused on delivering specific measurable business outcomes. Project management focuses on deliverables, while program management focuses on project interdependencies and the delivery of identified benefits.

A global program management architecture (GPMA) may serve as a framework for the management of a program. The GPMA provides a framework for the start-up, planning, execution, operations, and support of a program.

Governance 12 establishes clear roles, responsibilities and accountabilities for organizational constituents, including executive leadership and program manager 22. Governance 12 oversees and manages spending and working to provide an acceptable return on investment. Governance 12 includes identification of a program sponsor 19. Program sponsor 19 comprises a senior executive who endorses the program charter and has the authority to control the allocation and retention of required resources, enforce priorities established for program 11, and obtain timely cooperation of the participants. Program sponsor 19 provides knowledge of the business landscape associated with program 11 and monitors program definitions and objectives. The business landscape comprises the integration of business drivers, organizational hierarchies, and high level business processes into a business perspective, including issues and insights, that are regularly revised to show progress. The program definition and objectives comprise the scope and boundaries of program 11 and the commitment to delivering benefits.

In one embodiment, governance 12 further comprises a steering committee 20, a program manager 22, a program office 24, and one or more project managers 26. Steering committee 20 provides guidance and oversight for program 11 and works with program manager 22 to connect program goals with the strategic business plan, supports business sponsorship of program 11. Steering committee 20 further provides external perspective on program direction, risks and issues, institutionalizes management strategies that lie outside the scope of program 11, and serves as a program change control board. Steering committee interacts with enterprise leadership to provide periodic program status and reports. Steering committee 20 also communicates and escalates issues requiring enterprise management intervention, communicates red flags, and acts as a focal point for enterprise-management interaction. Steering committee 20 interacts with program manager 22 and program office 24 to convene periodic steering committee status meetings to review program status, to track programs, to facilitate implementation of program action plans, to resolve issues that could not be resolved at the program level, to review program status progress, to make plans for improving the program, to approve program plans and directions, and to communicate to program manager 22 based on input from program sponsor 19, an enterprise sponsor, and enterprise leadership.

Program manager 22 comprises a human leader of program office 24 who is responsible for program office 24. Program manager 22 works with employees of program office 24 to accomplish the goals of program office 24.

Program office 24 is responsible for achieving the business objectives of program 11, achieving benefits associated with program 11 and fulfilling the mandate of enterprise stake holders. Program office 24 is also responsible for allocating and re-allocating resources within program 11, adhering to the business plan, representing program 11 on meetings of steering committee 20, allocating and re-allocating assets within program 11, and managing day-to-day program office activities.

Program office 24 also interacts with steering committee 20 by providing periodic status reports, escalating issues that cannot be resolved at the program level, and communicating program action plan issues to appropriate persons. Further, program office 24 acts as a focal point for communication with steering committee 20, provides program plans and direction to steering committee 20 for approval, and communicates action plans based on steering committee recommendations. Program office 24 also interacts with other programs 11 to identify external influences and communicate the external influences to other programs 11 and to coordinate with other programs 11. Program office 24 is additionally responsible for interacting with other projects 11 by leading cross-project planning, dependency, and conflict resolution. Further, program office 24 monitors project progress with respect to delivery of program milestones, ensures implementation of project action plans, resolves issues that cannot be resolved at the project level and ensures compliance of projects with program office policies and procedures. In addition, program office 24 develops and promotes program management standards and project standards, provides interprogram and intraprogram communications, and mitigates project risk.

Project management 26 comprises day-to-day management, monitoring, and control of project activities, ensuring completion of project deliverables based on project milestones, managing project budgets, projecting resources, and managing achievement of project benefits. Project management 26 also applies disciplined project management techniques to project 27, communicates to project sponsors and other stakeholders project related information, identifies and resolves project issues and risks, escalating project risks and issues to program office 24, and communicates with other project managers 26 on initiatives to facilitate integration. Project managers 26 also interact with program manager 22 and program office 24 by providing periodic status reports to program office 24, escalating issues and risks that cannot be resolved at the project level, acting as a focal point for communication with program office 24, communicating significant scope and/or scheduled changes to program office 24 and communicating resource requirements to program office 24.

Program management disciplines 14 comprise methodologies and processes for supporting program management. More specifically in one embodiment, program management disciplines 14 comprise one or more of program scope management 30, communications management 32, program value management 34, program resource management 36, program issue management 38, program risk management 40, program performance monitoring 42, program quality management 44, program financial management 46 and program procurement management 48.

Knowledge management 16 comprises methodology and processes for applying past experiences to assist in future efforts. For example, knowledge management 16 may include processes associated with determining problems associated with a previous project, determining the solutions used for those problems, and documenting the problem and solution for future use.

Program scope management 30 comprises one or more of defining project delivery milestones in terms of benefit, cost, timing and resource requirements, identification of cross-project milestone interdependency, and evaluation of significant change requests with respect to program benefits. For example, a program benefit may comprise a financial benefit associated with the program, such as decreasing cost to the client. Program scope management 30 also includes handling cross-project change requests, project level change requests requiring escalation and communication of decisions related to project 27. In addition, scope managment 30 may include billing the client and working to see that the contracted revenue stream is received. In various embodiments, any or all of these elements may be used in various combinations as appropriate.

Program communications management 32 comprises one or more of managing communication between governance 12 and program entities, such as projects 27, program office 24 and others. The communications may include the content of ongoing projects 27, compliance with respect to projects 27 and architecture 10, and personnel and timelines associated with projects 27 in architecture 10. Also, program communications management 32 receives standing reports from program work streams, communicates decisions to program work streams, communicates action plans resulting from program issues, and communication of cross-project information. In various embodiments, any or all of these elements may be used in various combinations as appropriate.

Program value management 34 comprises one or more of assessment and evaluation of internal and external benefit propositions for program 11, monitoring for change within a business landscape associated with the program 11, assessment and evaluation of program decisions in terms of related impact to the projected value returned from program 11, derivation of internal and external program priorities based on value contributions, timing and status of interdependent program milestones, and assessment of internal program benefit propositions. Program value management 34 includes receiving of project issues that may directly or indirectly affect the internal and/or external program benefit propositions. A benefit status may be associated with one or more program benefits for tracking the status of the program benefit. For example, a financial status indication may be used to indicate the status of a financial program benefit. In various embodiments, any or all of these elements may be used in various combinations as appropriate.

Program resource management 36 comprises allocation of assets, such as physical and human assets to projects 27 based on program value priorities based on program value management 34 and an executive agenda for program 11. Program resource management 36 also comprises resolution of conflicts between a single asset and multiple demand requirements, and definition of a time-phased resource deployment strategy based on program priorities and program milestone interdependencies. In addition, program resource management 36 escalates resource management issues as a result of conflicts or constraints and escalates incremental resource requirements and unplanned resource consumption through a reporting process to program office 24 and goverance 12. In various embodiments, any or all of these elements may be used in various combinations as appropriate.

Program issue management 38 comprises identification and management of program issues, assessment of issue impact against program milestones, and recognition of interdependent implications as a result of an issue. Program issue management 38 also defines and manages action plans necessary to derive resolution of an issue, communicates open issues to program governance 12, communicates actions taken to resolve an issue to associated entities affected by the issue and proactive recognition of program issues. Program issue management 38 also includes escalation of project related items, such as changes, resources and financial issues, manifested by issue management to program office 24 and resolution of an issue communicated through notice of decisions to affected parties which may include multiple projects 27 and/or programs 11. In general, a notice of decision comprises a particular communication method and/or form used to communicate a decision to relevant audiences. For example, a notice of decision may comprise a distribution list and an system architechture document for communicating decisions regarding system design to implementors, such as programmers, of the system. In various embodiments, any or all of these elements may be used in various combinations as appropriate. Project issue management 58 comprises escalating project management elements which cannot be resolved by the project governance structure to program office 24 for resolution.

Program risk management 40 comprises identification and management of program risks which would impact and threaten the success of program 11 if unmanaged. Program risk management 40 further includes direct management of risks with respect to benefits, resources, progress, interdependencies and quality of program 11, identification of program related risk, and implementation of mitigation and transferring tactics which may be employed to manage exposure. Program risk management 40 also comprises definition and execution of a program risk plan, identification and management of a program contingency plan, and management of cross program risk. Program risk management 40 also includes monitoring of interdependent project risks and communication of interdependent program risks and related mitigation and transferred tactics. In various embodiments, any or all of these elements may be used in various combinations as appropriate.

Program performance monitoring 42 comprises identification and timing of key project milestones within project 27 and the interdependencies of the milestones. Interdependencies may exist within project 27, between projects 27 within program 11, between projects 27 and different programs 11, and between different programs 11. Program performance monitoring 42 further comprises proactive measurement and reporting of progress against key program milestones, definition and implementation of action plans for meeting milestones, and management of issues and communications related to the program milestones. Program performance monitoring 42 further includes receipt and consolidation of project status information and downward communication of action plans related to achieving the program milestones. In various embodiments, any or all of these elements may be used in various combinations as appropriate.

Program quality management 44 comprises determining definitions of program quality criteria, and systemic management of overall program quality. Program quality management 44 further comprises conducting project health checks and conducting quality assurance inspections. In addition, program quality management 44 includes issue escalation as a result of project quality being compromised or threatened, proactive management of interdependent project quality, management of executive support for standard processes, methods and tools, and standardized continuous improvement process defined for all programs. In various embodiments, any or all of these elements may be used in various combinations as appropriate.

Program financial management 46 comprises determining the program's financial strategy, determining an expected revenue and cost baseline, and monitoring and reporting the program's financial performance. Program financial management 46 also includes resolving variances that have exceeded thresholds, addressing scope changes, risks, and issues, and re-baselining as needed. In various embodiments, any or all of these elements may be used in various combinations as appropriate.

Program procurement management 48 comprises controlling revenues relative to contractual commitments. Program procurement management 48 allows program manager 22 to monitor contractual commitments on an ongoing basis and take corrective actions to promote adherence to the contract. Program manager 22 and program office 24 may also negotiate and monitor sub-contractors.

Project management methodology 18 comprises processes and methodology associated with project management. More specifically in one embodiment, project management methodologies 18 comprise one or more of project scope management 50, project communications management 52, project value management 54, project resource management 56, project issue management 58, project risk management 60, project performance monitoring 62, project quality management 64, project financial management 66 and project procurement management 68. Architechture 10 may also be used with other suitable project management methodologies.

Project scope management 50 comprises scope management at the project level. More specifically, project manager 26 works with the project team to identify requirements and deliverables. Project manager 26 also establishes an understanding and agreement with the customer about the project requirements. Project manager 26 divides the work into manageable tasks so that the cost and completion date of project 27 can be forecast. Project scope management 50 also includes providing a baseline project plan against which the impact of potential scope changes on schedule, budget, and performance requirements are evaluated. Project scope management 50 also includes escalation of change requests and/or change related issues to program office 24 and communication of decisions through notice of decisions to program office 24.

Project communications management 52 comprises determining types of messages to send, the recipient of the message, when to send the messages, and the composition of the messages so that project participants understand the message. Project manager 26 also monitors communication activities to ensure that the effectiveness of projects processes are established and maintained. Project communications management 52 also includes communication of status in terms of key project milestones, and communication of escalated project issues to program office 24.

Project value management 54 comprises escalation of project issues that may directly or indirectly affect the internal or external program benefit proposition in terms of project benefits to program 11.

Project resource management 56 comprises management of both physical and human resources with respect to project 27. Management of human resources includes creating strategy and determining procedures for timely and cost effective acquisition, use, and reallocation of human resources to provide quality products and services. Project manager 26 coaches, motivates, directs and provides training for human resources for successful project performance. Management of physical resources includes management, fulfillment, and deployment of physical resources, such as space and equipment. Physical resource management also includes defining strategy and accounting for all assigned assets, escalation of unresolved resources to program office 24 and utilization of time recording to record actual and forecast physical resource consumption.

Project risk management 60 comprises systematically assessing and managing the risk factors at project 27 by identifying specific risk items. Risk may be managed by taking action to accept, transfer, or mitigate that risk. Project manager 26 and other project participants may create contingency plans to reduce uncertainties and consequences. Project risk management 60 also includes communication and escalation of acute project risk to program office 24 for notification to others and management of the risk, and communication and escalation of interdependent risks to program office 24 for notification to other projects and programs of the risk. By reducing risks, the probability of success for project 27 is increased by increasing the predictability of the project and decreasing the opportunities for failure.

Project performance monitoring 62 comprises creating a project schedule to encompass deliverables and resources required within the scope of the project. Program manager 26 evaluates the viability of the schedule, ensures that work is accomplished, validates that resources are expended as planned and updates the schedule as the project progresses. Project performance monitoring 62 further includes upward reporting of progress toward key project milestones and escalation of issues and risks related to meeting key project milestones.

Project quality management 64 comprises working with the client of project 27 to define performance requirements and together creating a plan to achieve the specific performance requirements. All project participants are involved to ensure that plans and procedures are followed. Performance counter to the project's requirements, goals and standards is analyzed and progress is inspected at appropriate points to ensure compliance with the expectations of both the client and the project team. Project quality management 64 further includes the common processes, guidelines, standards and tools for delivery of applications and service, and standardized continuous improvement processes for all projects.

Managing projects 27 includes various management disciplines. Project financial management 66 comprises cost management and financial management. Cost management comprises establishing a financial infrastructure to support the estimating, forecasting, budgeting, and tracking of project economics. An associated billing plan establishes procedures for submitting requests for payment. Financial management comprises management of financial elements of project 27, such as revenue, profit, loss, billing and collections. Also, project financial management 66 includes upward reporting of financial progress and escalation of issues and risks relating to financial targets.

Project procurement management 68 comprises controlling revenues relative to project level contractual commitments. Project procurement management 68 allows a project manager to monitor contractual commitments on an ongoing basis and take corrective actions to promote adherence to the contract. For example, the project manager may be responsible for communicating billings to program manager 22 and working to see that the contracted revenue stream is received.

In operation, a company may use global program management architecture 10 for managing multiple projects 27 and programs 11. Project management methodologies 18 are used to manage particular projects 27 while program management disciplines 14 are used to manage multiple projects 27 and programs 11. For example, project management includes detailing the project plan, managing day-to-day operations of project 27, operating project 27 within the parameters set up by program 11, delivering service and executing work, developing project deliverables, managing detailed work plans, escalating issues that cannot be resolved at the project level, and escalating risks that should be transferred to other projects 27 or programs 11. In contrast, program management includes managing an overall picture and informing projects of their place within the big picture, ensuring executive governance, identifying and managing critical success factors, benefits, issues and risks associated with the program, removing project roadblocks when required, maintaining project sponsor support and alignment, coordinating with other programs 11, assigning budgets, resources and time to the project managers 26, ensuring that projects 27 are on track to meet plans, forecasting future performance for planning based on current inputs, actively managing interdependencies between projects 27, managing change at the enterprise level, and placing strategic intent into action by following the business plan.

FIG. 1A is a block diagram illustrating a computer system operable to support architecture 10. The computer system comprises one or more clients 70, one or more users 72 and one or more servers 76.

Clients 70 comprise electronic computing systems operable to receive data from users 72 for storage, processing and communication. For example, client 70 may comprise a general purpose personal computer (PC), a Macintosh, a workstation, a UNIX-based computer or other suitable devices. Clients 70 are operable to communicate with server 76. For example, clients 70 may communicate with server 76 over a data network.

Clients 70 further comprise a processor 80 and storage 82. Processor 80 comprises a suitable general purpose or specialized electronic managing bulk distribution assets device, such as an application specific integrated circuit (ASIC), a field programmable gate array (FPGA), a general purpose central processing unit (CPU), other suitable hardware operable to execute logic and other instructions stored in storage 82.

Processor 80 is operable to execute logic and instructions associated with architecture 10. Storage 82 comprises suitable transient and/or persistent computer readable storage, such as a computer readable medium, either alone or in suitable combination. For example, storage 82 may comprise magnetic storage, optical storage, electronic storage, such as random access memory (RAM), dynamic RAM (DRAM), and other suitable physical or electronic storage in suitable combination. Storage 82 is operable to store logic, such as a computer program or application, executable by processor 80. While processor 80 and storage 82 are shown as separate elements, processor 80 and storage 82 may be combined, such as in a CPU with embedded RAM. Alternatively, processor 80 and storage 82 may represent software, a combination of software and hardware, or be hardware only.

User 72 comprises a human or automatic process operable to input information to client 70 and receive information from client 70.

Server 76 comprises an electronic computing device operable to receive, transmit, process and store data associated with architecture 10. For example, client 70 may comprise a general purpose personal computer (PC), a Macintosh, a workstation, a UNIX-based computer, a server computer or other suitable devices. Server 76 is operable to communicate with clients 70. For example, server 76 may communicate with clients 70 over a data network.

Server 76 further comprises a processor 84 and storage 86. Processor 84 comprises a suitable general purpose or specialized electronic managing bulk distribution assets device, such as an application specific integrated circuit (ASIC), a field programmable gate array (FPGA), a general purpose central processing unit (CPU), other suitable hardware operable to execute logic and other instructions stored in storage 86.

Processor 84 is operable to execute logic and instructions associated with architecture 10. Storage 86 comprises suitable transient and/or persistent computer readable storage, such as a computer readable medium, either alone or in suitable combination. For example, storage 86 may comprise magnetic storage, optical storage, electronic storage, such as random access memory (RAM), dynamic RAM (DRAM), and other suitable physical or electronic storage in suitable combination. Storage 86 is operable to store logic, such as a computer program or application, executable by processor 84. While processor 84 and storage 86 are shown as separate elements, processor 84 and storage 86 may be combined, such as in a CPU with embedded RAM. Alternatively, processor 84 and storage 86 may represent software, a combination of software and hardware, or be hardware only.

In operation, program management disciplines 14 may be supported by clients 70 and server 76. For example, program resource management 36 may use a database stored on storage 86 to map and track resources associated with program 11 and projects 27. More specifically, the database may provide current information regarding the disposition and assignment of resources associated with the program. In one embodiment, resources may comprise one or more of a human, a physical item, such as a desk, space, such as an office, and a non-physical item, such as computer program. For example, a database of information may be stored at server 76 and information in the database may be communicated to users 72 through clients 70. In addition, users 72 may update the database by communicating data through clients 70 to server 76.

FIG. 2 is a block diagram illustrating stages associated with program 11. Typically, programs 11 go through various stages during their lifecycle. The stages associated with program 11 comprise a start-up phase 100, a planning stage 102, an execution stage 104, an operation stage 106, a support stage 108, and a close down stage 110.

Program start-up stage 100 comprises conceiving a program based on strategic analysis, a signed contract with the client, and/or an existing business need. More specifically, program start-up stage 100 comprises determining whether a particular activity will benefit from program management, identifying project management processes to be deployed by constituent projects 27, and creating an initial program charter. The program charter comprises a set of specific boundaries around what program 11 is intending to achieve in terms of organizational impact, organizational involvement, geographic impact and coverage, and logical scope coverage.

Program activities related to program start-up stage 100 are organized in multiple work streams to deliver a series of critical results, such as key program milestones. The key program milestones are typically work stream specific, but are often interdependent with other milestones. Program start-up stage 100 further comprises establishing an initial program governance structure, staffing program 11 and operationalizing program 11, establishing a program workbook, and determining initial program standards and procedures. Also, program start-up stage 100 comprises reviewing and tailoring scope management discipline, creating initial constituent project scopes, reviewing and tailoring the communication management discipline, and preparing an initial program communication plan.

Start-up stage 100 further comprises reviewing and tailoring the value management discipline, documenting program benefits identified in the program charter. Program start-up stage 100 also includes reviewing and tailoring program management disciplines 14 for use with the particular program 11 being started. Also, program start-up stage 100 includes identifying automated program and project management tools for assisting with document maintenance and control, determining initial criteria and thresholds for determining when projects should escalate issues and risks to program manager 22 in program office 24. Also, start-up stage 100 comprises announcing program 11 using a program communication process by communicating to the organization information about program 11 so that members of the organization not directly connected with program 11 understand the program's scope, sponsorship and impact upon them personally.

Program planning stage 102 comprises an interactive process for translating the program charter into a set of specific projects 27. Program planning stage 102 finalizes the program organization and governance structure, and provides a supporting infrastructure that includes, for example, standard tools and templates. Each project 27 is assigned a precise scope, revenue, cost, resource, and schedule constraints within which to operate. Each project leader then translates the project scope into detailed tasks. Program planning stage 102 comprises ensuring deployment of a project management process set by constituent projects 27, refining the program scope as described in the program charter, consolidating and reconciling project scopes into the program scope and addressing the gaps between the project scopes at the program level. Program planning stage 102 further includes reconciling benefits to be achieved through each project 27 with the program benefits and addressing gaps between the project benefits at the program level. Also, program planning stage 102 includes defining a project resource plan to consolidate and reconcile project and program resource plans and address gaps between resource plans at the program level. In addition, program planning stage 102 includes capturing initial project issues and risks, refining reporting and review procedures for both internal and external entities, reconciling project schedules with the program milestones schedule and addressing gaps in the project schedules at the program level. Further, program planning stage 102 includes reconciling one or more project metrics with the program metrics and addressing gaps between the project metrics within the program 11 at the program level, consolidating and reconciling project revenue and cost baselines with program revenue and cost baselines, determining expenses of program office 24, and establishing the revenue and cost baselines for program 11. Also, program planning stage 102 includes refining criteria, thresholds, and variances for determining when projects 27 should escalate changes, issues and risks to program manager 22 and program office 24, conducting a program plan walk through which includes rationalization of the program charter, the client contract, and the project statements of work, and setting baseline program plans and communication plans.

Program execution stage 104 comprises initiating and using program management disciplines 14 to successfully manage program 11. Plans associated with program 11 are executed and followed, processes and supporting tools are applied to manage program 11 and control the achievement of tangible business benefits. Program execution stage 104 further comprises updating the program charter to address modifications that result from scope changes, following scope management discipline 30 to maintain accurate scope and program focus, following program communication plans and updating the program communication plans as appropriate, and ensuring that program status meetings, program change control board meetings, and program steering committee meetings are conducted on a regular basis. Also, program execution stage 104 includes monitoring benefits, monitoring a resource plan for program office 24, monitoring issues, and identifying, assessing, and mitigating risks.

Further, program execution stage 104 comprises monitoring program milestone schedules against the progress of constituent projects 27, monitoring project interdependencies, updating the program metrics as appropriate, comparing revenue and cost baselines with actual revenues and costs, validating the revenues and costs, calculating and researching variances, and generating associated reports. In addition, program execution stage 104 comprises monitoring program variances, monitoring constituent project variances, utilizing established thresholds and variance criteria, preparing and distributing periodic program status reports to program stakeholders, refining reporting and review procedures, and conducting a quarterly program health check.

Program execution stage 104 further includes conducting project health checks on constituent projects 27 on a regular basis, conducting client satisfaction surveys, applying quality metrics to evaluate program performance, conducting employee satisfaction surveys and monitoring client contract and subcontracts.

Program operation stage 106 comprises implementing projects 27 throughout the life cycle of project 27. More specifically in one embodiment, program operation stage 106 includes performing project related tasks in the context of the program associated with the project. Program operation stage 106 includes confirming that the implementation of projects 27 fulfills the requirements of the program charter, assessing and obtaining approval for scope changes to projects 27 as a result of the particular implementation, updating the program charter to address modifications resulting from the particular project implementation chosen and documenting benefits achieved and not achieved by the particular project implementation. In addition, program operations stage 106 comprises documenting and logging benefits monitored as a result of the particular project implementation, assessing risks identified as a result of the particular project implementation, re-allocating staff among projects using the program resource management plan, documenting and logging new program issues to identify results of the particular project implementations, and conducting a client satisfaction survey with respect to program 11. Further, program operation stage 106 includes conducting an employee satisfaction survey with respect to program 11, documenting lessons learned from the particular project implementations, distributing lessons learned to others, and updating program metrics relative to the particular project implementation.

Program support stage 108 comprises consulting, training and document management with respect to program 11. In general, program support stage 108 includes the support and administrative processes for operating program 11. In particular, program support stage 108 comprises orientation activities to help new resources become familiar with the program objectives, utilization of knowledge management 16 to capture and leverage cross-project information, controlling of program documents, developing a set of practical guidelines and checklists for space, furniture, equipment issues, access to client networks, telephones and administrative support, and developing a structured technique to support team building in project teams and between teams.

FIG. 3 is a flow chart illustrating a method for performing program management. The method begins at step 200, where governance 12 is determined. More specifically, a governance structure is determined for managing program 11. Next, at step 202, the program governance structure determined in step 200 is applied to program 11. For example, the identity of program manager 22 and the number of employees in program office 24 may be determined. In one embodiment, software stored on storage 82 and/or 86 and executable by processor 80 and/or 84 is operable to store and organize governance structure 12 and associated information, such as contact information associated with program manager 22.

Next, at step 204, one or more program management disciplines 14 may be applied to program 11. More specifically, members of governance 12, such as program manager 22, may determine which management disciplines 14 to apply to program 11 and how to apply those disciplines with respect to the specific program. For example, a multi-location program 11 may include different specifics with respect to resource management 36 than a single site program 11. For example, a program 11 that that involves implementing a new computer system over 13 different countries, in 130 different locations, in 9 different languages while changing the underlying business process of the client involves significantly more procedural structure that that of a program 11 creating a similar computer system for a single site in a single location. In general, as programs 11 vary in complexity and size, various disciplines 14 may or may not be appropriate for a particular program 11. In one embodiment, software may be used in associated with clients 70 and/or server 76 to track and manage which disciplines 14 are to be used and to what extent. For example, program 11 may have two associated projects 27 with differing management needs and the different disciplines 14 to be applied to projects 27 may be stored by the software.

Proceeding to step 206, knowledge management 16 is applied to program 11. More specifically, knowledge management procedures may be implemented for a particular program 11 being managed so that problems and related solutions are properly documented for use by others in the future. Next, at step 208, project management methodologies 18 are applied to projects 27 associated with program 11. More specifically, project management methodologies may be customized for the particular projects 27 being managed with respect to program 11. For example, a particular project 27 may have only three people working on the project and project resource management techniques applicable to hundreds of people may not be used on the three person project. In one embodiment, the knowledge management procedures may be stored in a database on server 76 and referenced by people involved in projects 27 and program 11. For example, a knowledge base may be referenced for assistance in determining appropriate management techniques.

FIG. 4 is a flow chart illustrating an exemplary embodiment of program value management 34. The method begins at step 300, where program manager 22 and program office 24 assess benefits associated with program 11. More specifically, benefits associated with program 11 with respect to deliverables, processes, and the client are assessed. Assessing program benefits 300 comprises, for example, identifying the particular benefits flowing from program 11.

Next, at step 302, benefits associated with program 11 are allocated to projects 27. More specifically, as program 11 is built from numerous projects 27, benefits resulting from program 11 often are realized with the efforts of individual projects 27. For example, a program to provide an integrated order fulfillment system may include a customer service project and an order tracking software project. Benefits associated with the order tracking software would be allocated to the order tracking software project and benefits associated with the customer service would be allocated to the customer service project.

Proceeding to step 304, program manager 22 and program office 24 set tracking of program benefits. Then, at step 306, program manager 22 and program office 24 set measuring of program benefits. More specifically, program manager 22 and program office 24 determine procedures for tracking benefits associated with program 11 and set measuring of those benefits. For example, a program benefit may be tracked by setting particular milestones for functionality associated with a software application. The benefits associated with the milestones may be measured by the number of errors in the functionality of the software application.

Then, at step 308, a benefit status associated with the program benefits is tracked. More specifically, a benefit status is associated with a benefit for representing a current status associated with the program benefit. Next, at step 310, program 11 is monitored and program benefits are tracked and measured and benefit statuses are updated. In one embodiment, benefits may be associated with particular projects 27 and tracked using software on server 76 and/or clients 70. For example, users 72 may update benefits and benefit status using clients 70 to update a master list at server 76. In one embodiment, the master list comprises a database on storage 86 and executed by processor 84.

Architecture 10 supports the management of multiple projects involved in a program. Architecture 10 allows for more efficient management and completion of the project.

Other changes, substitutions, and alterations are also possible without departing from the spirit and scope of the present invention, as defined by the following claims.

What is claimed is:

1. A method for program management comprising:
determining a governance structure for a program, the governance structure providing leadership for the program and including at least one member;
applying, by at least one member of the governance structure, at least one program management discipline to the program;
applying, by at least one member of the governance structure, knowledge management to the program; and
applying, by at least one member of the governance structure, at least one project management methodology to at least one project associated with the program.

2. The method for program management according to claim 1, wherein applying the governance structure comprises:
determining a steering committee associated with the program;
determining a program manager associated with the program;
determining a program office associated with the program; and
determining a project manager for the project.

3. The method for program management according to claim 1, wherein the program comprises a plurality of projects.

4. The method for program management according to claim 1, wherein applying the program management disciplines comprises applying value management to the program.

5. The method for program management according to claim 4, wherein applying value management comprises:
assessing at least one program benefit associated with the program;
allocating the program benefits to the projects;
determining tracking for the rogram benefits;
determining measurements for the program benefits; and
tracking a benefit status associated with the program benefits.

6. The method for program management according to claim 5, wherein the program benefit comprises a financial benefit.

7. The method for program management according to claim 5, wherein the benefit status comprises a financial status indicator.

8. The method for program management according to claim 5, wherein determining tracking for the program benefit comprises:
examining the program benefit;
establishing a measure associated with the program benefit;
establishing a baseline associated with the measure;
determining a trigger associated with the program benefit;
integrating the trigger into a program plan associated with the program and a project plan associated with the project;
approving the program benefit, the baseline and the measure;
updating documentation associated with the program benefit; and
updating a log associated with the program benefit.

9. The method for program management according to claim 5, wherein assessing the program benefit comprises:
reviewing a program charter associated with the program;
revising sales documentation associated with the program; and
reviewing financial goals associated with the program and the project.

10. The method for program management according to claim 9, wherein assessing the program benefit further comprises:
linking external benefits associated with the program to a strategic goal associated with a client;
linking internal benefits associated with the program to a benefits plan;
determining whether the program benefits expose the program to a legal liability;
documenting achievement of the program benefit;
determining whether the program benefits are achievable with respect to capabilities associated with the client;
escalating the program benefit if the program benefit is not achievable with respect to capabilities associated with the client; and
respectively documenting each program benefit.

11. The method for program management according to claim 5, wherein allocating the program benefits to the projects comprises:
determining interdependencies between the projects based on respective charters associated with the projects with respect to at least one project benefit respectively associated with the projects;
allocating the program benefits to the projects;
reconciling gaps between the program benefits and the project benefits;
tracking coordination between the project benefits and the program benefits;
documenting risks associated with the project benefits; and
updating the program benefits based on the project benefits.

12. The method for program management according to claim 5, wherein determining measurements for the program benefits comprises:
determining a financial measure associated with the program benefit; and
determining an operating measure associated with the program benefit.

13. The method for program management according to claim 12, wherein the financial measure comprises a revenue based measurement.

14. The method for program management according to claim 12, wherein the financial measure comprises an earned value analysis based measurement.

15. The method for program management according to claim 12, wherein the operating measure comprises a time-to-market based measurement.

16. The method for program management according to claim 12, wherein the operating measure comprises a head count based measure.

17. The method for program management according to claim 5, wherein tracking the benefit status comprises:
reviewing current documentation associated with the program benefits;
discussing concerns associated with the program benefits with an audience based on the concerns and the program benefits; and
generating an issue in response to determining that at least one of the program benefits will not be achieved.

18. A method for program value management comprising:
assessing at least one program benefit associated with a program, the program having at least one associated project;
determining at least one program benefit associated with the program;
allocating the program benefits to the projects;
determining tracking of the program benefits; and
determining measurement of the program benefits.

19. The method for program value management according to claim 18 and further comprising:
reviewing current documentation associated with the program benefits;
discussing concerns associated with the program benefits with an audience based on the concerns and the program benefits; and
generating an issue in response to determining that at least one of the program benefits will not be achieved.

20. The method for program management according to claim 19, wherein the benefit status comprises a financial status indicator.

21. The method for program value management according to claim 18, wherein the program benefit comprises a financial benefit.

22. The method for program value management according to claim 18, wherein determining tracking of the program benefit comprises:
examining the program benefit;
establishing a measure associated with the program benefit;
establishing a baseline associated with the measure;
determining a trigger associated with the program benefit;
integrating the trigger into a program plan associated with the program and a project plan associated with the project;
approving the program benefit, the baseline and the measure;
updating documentation associated with the program benefit; and
updating a log associated with the program benefit.

23. The method for program value management according to claim 18, wherein assessing the program benefit comprises:
reviewing a program charter associated with the program;
revising sales documentation associated with the program; and
reviewing financial goals associated with the program and the project.

24. The method for program value management according to claim 23, wherein assessing the program benefit further comprises:
linking external benefits associated with the program to a strategic goal associated with a client;
linking internal benefits associated with the program to a benefits plan;
determining whether the program benefits expose the program to a legal liability;
documenting achievement of the program benefit;
determining whether the program benefits are achievable with respect to capabilities associated with the client;
escalating the program benefit if the program benefit is not achievable with respect to capabilities associated with the client; and
respectively documenting each program benefit.

25. The method for program value management according to claim 18, wherein allocating the program benefits to the projects comprises:
determining interdependencies between the projects based on respective charters associated with the projects with respect to at least one project benefit respectively associated with the projects;
allocating the program benefits to the projects;
reconciling gaps between the program benefits and the project benefits;
tracking coordination between the project benefits and the program benefits;
documenting risks associated with the project benefits; and
updating the program benefits based on the project benefits.

26. The method for program value management according to claim 18, wherein determining measurement of the program benefits comprises:
determining a financial measure associated with the program benefit; and
determining an operating measure associated with the program benefit.

27. The method for program value management according to claim 23, wherein the financial measure comprises a revenue based measurement.

28. The method for program value management according to claim 23, wherein the financial measure comprises an earned value analysis based measurement.

29. The method for program value management according to claim 23, wherein the operating measure comprises a time-to-market based measurement.

30. The method for program value management according to claim 23, wherein the operating measure comprises a head count based measure.

31. A system for program management comprising:
means for determining a governance structure for a program, the governance structure providing leadership for the program and including at least one member;
means for applying, by at least one member of the governance structure, at least one program management discipline to the program;
means for applying, by at least one member of the governance structure, knowledge management to the program; and
means for applying, by at least one member of the governance structure, at least one project management methodology to at least one project associated with the program.

32. A system for program value management comprising:
means for assessing at least one program benefit associated with a program, the program having at least one associated project;
means for determining at least one program benefit associated with the program;
means for allocating the program benefits to the projects;
means for determining tracking of the program benefits; and
means for determining measurement of the program benefits.

33. A system for program management comprising:
logic stored on storage and operable to:
maintain at least one program management discipline associated with a program;
respectively associate the at least one program management discipline with at least one project associated with the program;
track information associated with the program management disciplines; and
communicate information associated with the program management disciplines to a user.

34. The system for program management according to claim 33, wherein a one of the program management disciplines comprises program value management and the logic is further operable to maintain a master list associated with tracking a benefit status associated with a benefit associated with the program value management.

35. The system for program management according to claim 33, wherein the logic is further operable to maintain a database of information associated with the program.

36. The system for program management according to claim 33, wherein a one of the program management disciplines comprises resource management and wherein the logic is further operable to track the disposition and assignment of resources associated with the program.

37. The system for program management according to claim 36, wherein the resource comprises a human.
